(19) United States
(12) Patent Application Publication
(10) Pub. No.: US 2005/0023818 A1
(43) Pub. Date: Feb. 3, 2005

(54) Books having removable panels for forming structures

(76) Inventor: Dennis R. Hughes, Edinburg, TX (US)

Correspondence Address: HANLEY, FLIGHT & ZIMMERMAN, LLC, 20 N. WACKER DRIVE, SUITE 4220, CHICAGO, IL, 60606, US

(21) Appl. No.: 10/628,713

(22) Filed: Jul. 28, 2003

(51) Int. Cl. B42D 1/00

(52) U.S. Cl. 281/15.1

(57) ABSTRACT

A book-like article having a plurality of story panels that are removably attached to each other and that, upon removal, can be assembled to form a building-like structure. Each of the story panels is attached to another one of the plurality of story panels. At least one of the story panels includes normally visible textual information on a first surface and normally hidden graphical information on a second surface. Some of the story panels are removably attached to a book-like article and configured to be assembled to form a building-like structure consistent with the textual information.

### FIELD OF THE DISCLOSURE

The present disclosure relates generally to book-like articles, and more particularly, to books having removably attached story panels that are configured to form building-like structures.

### BACKGROUND

The desire to increase a child's reading comprehension and retention rate has sparked an increase in creative products and learning activities associated with those products. For example, a child's reading comprehension skills can be greatly improved through the use of creative methods of reading books and hearing stories. Often the use of colorful illustrations, captivating characters and imagination are the primary manner in which a story is conveyed to a child. However, by improving the story experience, it may be possible to improve a child's comprehension and retention rate, thereby improving the overall learning experience.

The addition of other aspects and features to traditional methods of reading and story telling has helped to advance the pace at which children learn from the story experience. For example, interactive book structures are one way of improving the teaching effectiveness of reading and story telling. While interactive book structures contain textual information (e.g. a story) and graphical information (e.g. colorful illustrations) like any other book, these interactive book structures have additional interactive characteristics and features that improve the learning role of the reading and story telling experience. In particular, interactive book structures may include books that can be made to represent buildings, carousels, scenery and utilitarian structures. For example, U.S. Pat. No. 5,096,204 to Peter J. H. Lippman discloses a book or game board with an open and closed configuration having leaves interconnected by flexible hinges. The leaves disclosed by Lippman are physically limited to forming a distinct structure with a recognizable shape based on the placement of the flexible hinges on the leaves during manufacture of the book or game board. In another example, U.S. Pat. No. 4,946,414 to Kathleen M. Zimmer discloses a book structure in which holes are cut into several panels so that the panels can be joined side-by-side by an elastic hinge to form a book. In yet another example, U.S. Pat. No. 2,183,443 to Charles E. Bracker discloses a book having leaves that are permanently attached to a common binding and which are assembled into a final completed structure without removing the leaves from the common binding. While these above-mentioned patents generally disclose books that can be formed into various structures, these known books typically do not provide a story relevant to the structure in combination with a plurality of removable or detachable pages, one or more of which may be used to form multiple surfaces of the structure.

### BRIEF DESCRIPTION OF THE DRAWINGS

FIG. 1 depicts an example book-like article.

FIG. 2 depicts the example book-like article of FIG. 1 in an open-book configuration.

FIG. 3 depicts an example manner in which a plurality of story panels may be removably attached to each other to form an example book-like article such as for, example, the example book-like article shown in FIG. 1.

FIG. 4 illustrates an example manner in which one or more removably attached story panels may be removed from the example book-like article shown in FIG. 1.

FIG. 5 depicts an example multiple-panel spread story panel.

FIG. 6 is a plan view of an example multiple-panel spread story panel configured to form a roof portion of a building-like structure.

FIG. 7 depicts the example multiple-panel spread story panel of FIG. 6 folded to form an example roof portion of a building-like structure.

FIG. 8 is a plan view of an example multiple-panel spread story panel configured to form another roof portion of a building-like structure.

FIG. 9 depicts the example multiple-panel spread story panel of FIG. 8 folded to form another example roof portion of a building-like structure.

FIG. 10 is a plan view of an example multiple-panel spread story panel configured to form a gable structure.

FIG. 11 depicts the example multiple-panel spread story panel of FIG. 10 folded to form an example gable structure that is configured to be affixed or attached to a roof portion.

FIG. 12 is a plan view of an example multiple-panel spread story panel that may be configured to form another gable structure.

FIG. 13 depicts the example multiple-panel spread story panel of FIG. 12 folded to form another example gable structure that is configured to be affixed or attached to a roof portion.

FIGS. 14 and 15 are plan views of example multiple-panel spread story panels that are configured to form two multiple-wall portions of a building-like structure.

FIGS. 16 and 17 depict the example multiple-panel spread story panels of FIGS. 14 and 15 folded to form example multiple-wall portions.

FIG. 18 is a plan view of an example multiple-panel spread story panel that is configured to form a ceiling structure or a floor structure of a building-like structure.

FIG. 19 is the example multiple-panel spread story panel of FIG. 18 folded to form a ceiling structure or a floor structure of a building-like structure.

FIG. 20 is an exploded isometric view of a building-like structure that may be formed using the removably attached story panels described herein.

FIG. 21 is a detailed exterior view of an example building-like structure that may be formed using the removably attached story panels described herein.

FIG. 22 illustrates the access door of the example building-like structure of FIG. 21 in an open-door configuration.

FIG. 23 illustrates an example multiple-panel spread story panel configured to form a game.

FIG. 24 is an example game components panel.

### DETAILED DESCRIPTION

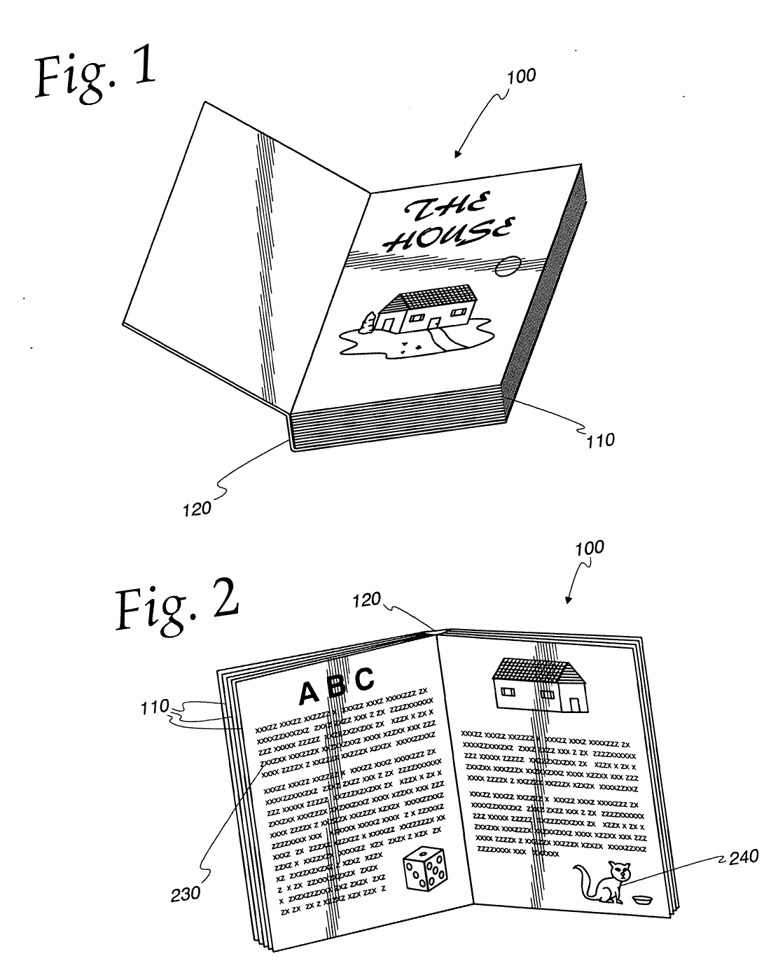

FIG. 1 depicts an example book-like article 100. The example book-like article 100 includes a plurality of story panels 10 that are removably attached at a common binding edge 120. As described in greater detail below, at least some of the story panels 10 are held in a closed-panel configuration when attached to another panel and/or the common binding edge 120 and may be configured to form an open-panel configuration upon removal from the example book-like article 100. In the closed-panel configuration, normally visible surfaces of one or more of the story panels 10 may include printed information (e.g., graphics, text, etc.) associated with a story and/or instructional information. Additionally, in the closed-panel configuration, one or more of the story panels 10 may include normally hidden graphical information that becomes visible when the story panels 10 are removed from the example book-like article 100 and configured in an open-panel configuration.

One or more of the story panels 10 may be adjacent to each other so that a normally visible surface of one story panel in a closed-panel configuration faces a normally visible surface of another story panel in the closed-panel configuration. In a closed-panel configuration, the story panels 10 may be placed adjacent to each other and attached at the common binding edge 120 so that a story or the like may be presented in a chronological or otherwise intuitive order or sequence.

When removed from the example book-like article 100 and formed in an open-panel configuration, one or more of the story panels 10 may be configured to expose normally hidden graphical information that is associated with a building-like structure. In addition, in an open-panel configuration, one or more of the story panels 110 may be attached to other ones of the story panels 110. Thus, when in an open-panel configuration, at least some of the story panels 10 may be assembled to form a building-like structure having exposed building-like graphical information.

FIG. 2 depicts the example book-like article 100 of FIG. 1 in an open-book configuration. As shown in FIG. 2, each of the story panels 10 may include normally visible textual information 230 and/or normally visible graphical information 240. In the closed-panel configuration, the normally visible textual information 230 and the normally visible graphical information 240 may be related to a story and/or instructional information.

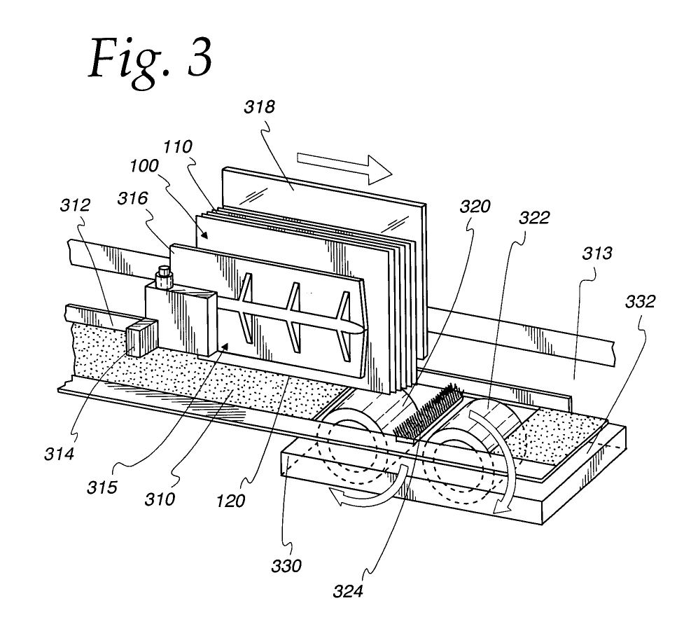

FIG. 3 depicts an example manner in which a plurality of story panels 10 may be removably attached to each other to form an example book-like article such as for, example, the example book-like article 100 shown in FIG. 1. The apparatus and process depicted in FIG. 3 includes a low-friction surface 310, a guide rail 312 adjacent to the low-friction surface 310, a track rail 313 adjacent to the guide rail 312 and a push block 314 that is coupled to the track rail 313 and is capable of traveling longitudinally along the guide rail 312 and the track rail 313. A clamping mechanism 315 that is used to hold the plurality of story panels 110 includes an outer clamping plate 316 that is mechanically coupled to the push block 314 and an inner clamping plate 318 that is coupled to the track rail 313. The push block 314, outer clamping plate 316 and inner clamping plate 318 move longitudinally along the guide rail 312 and the track rail 313.

To couple or otherwise affix the story panels 110 to form the example book-like article 100, the story panels 110 are held in the clamping mechanism 315 and the common binding edge 120 of the story panels 110 is registered against the low-friction surface 310. The push block 314 is then used to drive the plurality of story panels 110 along the low-friction surface 310 toward drum rollers 320 and 322 while the outer clamping plate 316 and the inner clamping plate 318 hold the plurality of story panels 110 together in an orientation that exposes the common binding edge 120 to drum rollers 320 and 322. In this manner, the drum rollers 320 and 322 may be used to apply an adhesive material 332 (e.g., a hot-melt fugitive adhesive) to the common binding edge 120.

The drum rollers 320 and 322 are disposed in an adhesive supply pan 330 that may be used to supply the adhesive material 332 to the drum rollers 320 and 322. In instances where the adhesive material 332 includes a hot-melt fugitive adhesive, the adhesive supply pan 330 may be heated using, for example, an electrical heating element (not shown). Using the adhesive material 332 to removably attach the plurality of story panels 110 to each other enables the plurality of story panels to remain unmarred from binding holes, binding slots and/or other such binding features.

The apparatus shown in FIG. 3 may include a brush 324 disposed between the drum rollers 320 and 322. The brush 324 may be used to drive the adhesive material 332 between adjacent surfaces of the plurality of story panels 110. Additionally, the drum rollers 320 and 322 may be configured so that the outer surface of the drum roller 320 is positioned at a slightly higher vertical position than the outer surface of the drum roller 322. In this manner, the drum roller 322 may be used to apply a finishing or smoothing layer of the adhesive material 332 to the plurality of story panels 110 to strengthen the common binding edge 120.

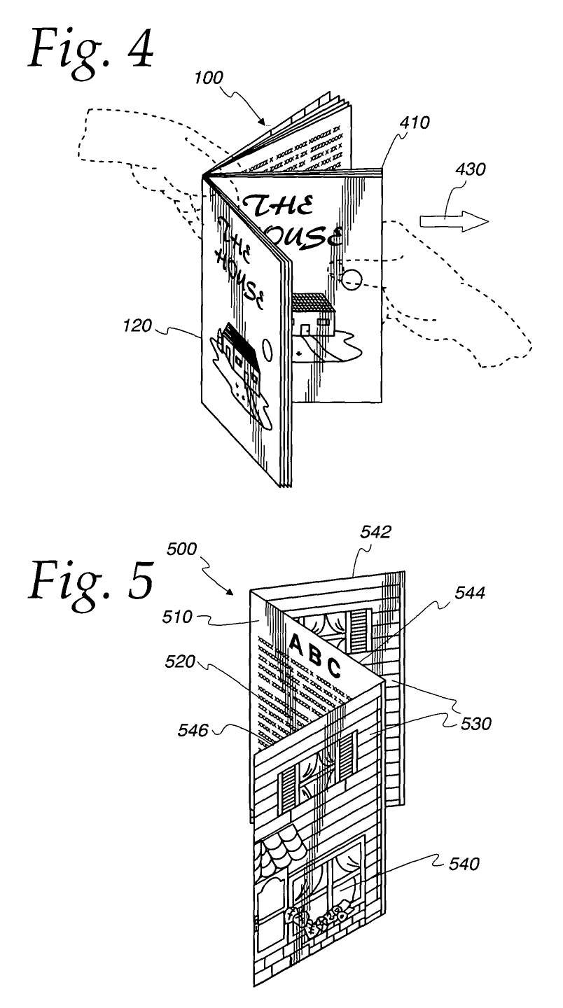

FIG. 4 illustrates an example manner in which one or more removably attached story panels 410 may be removed from the example book-like article 100 shown in FIG. 1. As depicted in FIG. 4, the example book-like article 100 includes the removably attached story panels 410 that are bound at the common binding edge 120. One or more of the removably attached story panels 410 are configured to be removed from the example book-like article 100 by pulling the removably attached story panels 410 away from the common binding edge 120 in a direction generally indicated by arrow 430. For example, one or more of the removably attached story panels 410 may be removed from the example book-like article 100 by hand. Once removed, one or more of the removably attached story panels 410 may be used in an open-panel configuration. In an open-panel configuration, one or more of the removably attached story panels 410 may provide a multiple-panel spread story panel, which may be used to form a building-like structure as described in greater detail below.

FIG. 5 depicts an example multiple-panel spread story panel 500. In a closed-panel configuration, the example multiple-panel spread story panel 500 includes at least one normally visible surface 510, having normally visible printed information 520 related to a story and/or instructional information thereon. In addition, in a closed-panel configuration, the example multiple-panel spread story panel 500 may also include normally hidden graphical information 530 and pop-out features 540 (e.g. windows and doors) that are associated with a building-like structure.

In an open-panel configuration, as depicted in FIG. 5, the example multiple-panel spread story panel 500 includes multiple panels in a unitary construction. In particular, the example multiple-panel spread story panel 500 of FIG. 5 includes three panels 542, 544 and 546. However, multiple-panel spread story panels having two panels or more than three panels could be used, if desired. In any case, a first side of a given panel may display normally hidden graphical information (e.g., the graphical information 530) and pop-out features (e.g., the pop-out features 540) while a second side of the given panel may display a normally visible surface (e.g., the surface 510) having normally visible printed information (e.g., the printed information 520) related to a story and/or instructional information thereon. After removal, the multiple-panel spread story panel 500 may be folded or configured to form a surface or section of a building-like structure and to expose a normally hidden graphical information (e.g., the graphical information 530) and pop-out features (e.g., the pop-out features 540) that are associated with a building-like structure.

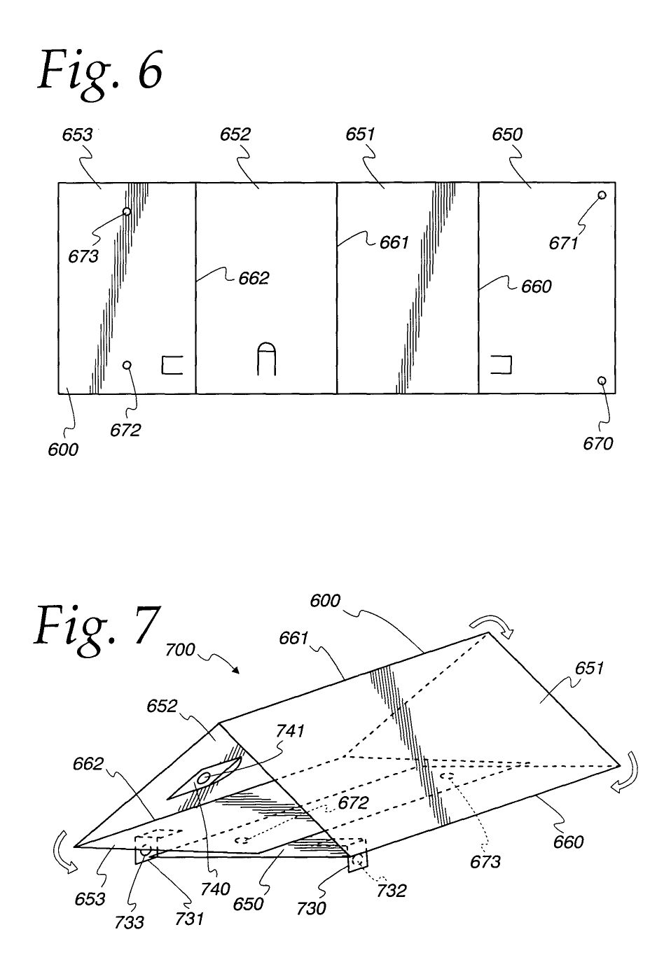

FIG. 6 is a plan view of an example multiple-panel spread story panel 600 configured to form a roof portion of a building-like structure. The example multiple-panel spread story panel 600 includes four sections or panels 650, 651, 652 and 653 that, when folded along three folding lines 660, 661 and 662, may form a roof portion of a building-like structure. The example multiple-panel spread story panel 600 also includes predetermined areas for the placement of adhesives or other fastening materials (e.g., glue, Velcro, etc.) and may include adhesive placement targets. In particular, the adhesive placement targets 670, 671, 672 and 673 facilitate the placement of an adhesive or other fastening material to enable the panel 650 to be affixed or attached to the panel 653.

The panels 650 and 651 of the example multiple-panel spread story panel 600 may be joined together to form a roof portion. In particular, an adhesive or other fastening material may be placed on the adhesive placement targets 670 and 671, which are located on the back side of panel 650, and the adhesive placement targets 672 and 673, which are located on the front side of panel 653. The panels 650, 651, 652 and 653 may then be folded about the folding lines 660, 661 and 662 to cause the back side of panel 650 to face the front side of panel 653. In this way, adhesive material placed on the adhesive placement targets 670 and 671 may be engaged with respective areas defined by the adhesive placement targets 672 and 673, which may also include an adhesive or other fastening material.

FIG. 7 depicts the example multiple-panel spread story panel 600 of FIG. 6 folded to form an example roof portion 700 of a building-like structure. The example roof portion 700 may be formed using the example multiple-panel spread story panel 600 by folding the panels 650, 651, 652 and 653 along the folding lines 660, 661 and 662 and engaging the front side of the panel 650 and the back side of panel 653 with an adhesive or other fastening material placed on some or all of the adhesive placement targets 670, 671, 672 and 673.

The example roof portion 700 is generally configured to be attached to a building-like structure. The panels 650 and 653 of the example roof portion 700 include respective engagement tabs 730 and 731. The engagement tabs 730 and 731 may be implemented using semi-perforated features that can be dislocated, popped-out or otherwise extended from the panels 650 and 653. For example, three sides or edges of the engagement tabs 730 and 731 may be joined to the respective panels 650 and 653 with semi-perforated features so that the engagement tabs 730 and 731 can be popped-out and remain attached or hinged by at least one edge to the panels 650 and 653. Furthermore, adhesive or other fastening materials may be placed on the engagement tabs 730 and 731 at adhesive placement targets 732 and 733, thereby enabling the example roof portion 700 to be affixed or attached to a building-like structure.

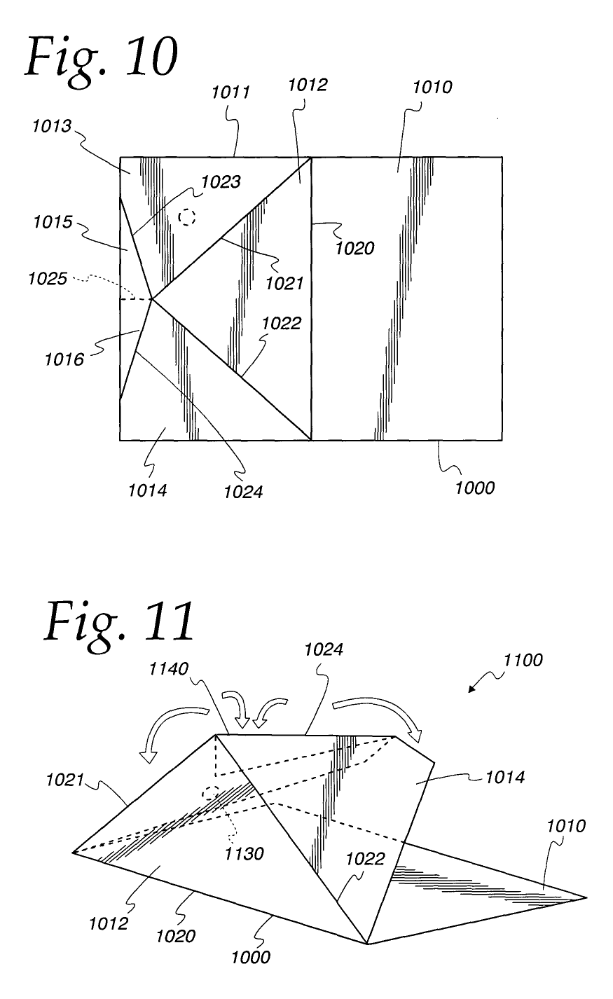

The example roof portion 700 is also configured to be attached to a gable structure (e.g., the example gable structures of FIGS. 10 and 13) via an adhesive or other fastening material. The panel 652 has an inset tab 740 that may be dislocated or popped-out on three sides from the panel 652. The inset tab 740 includes an adhesive placement target 741 on which an adhesive or other fastening material may be placed to engage with a gable structure.

The inset tab 740 also enables adjustment of the example roof portion 700 in relation to any adjoining structure (e.g., a gable structure). In particular, the inset tab 740 is configured so that, when engaged with a gable structure, a force applied to it will move the gable structure relative to the example roof portion 700. In this manner, the inset tab 740 may be used to adjust the position of a gable structure (or some other structure) relative to the example roof portion 700.

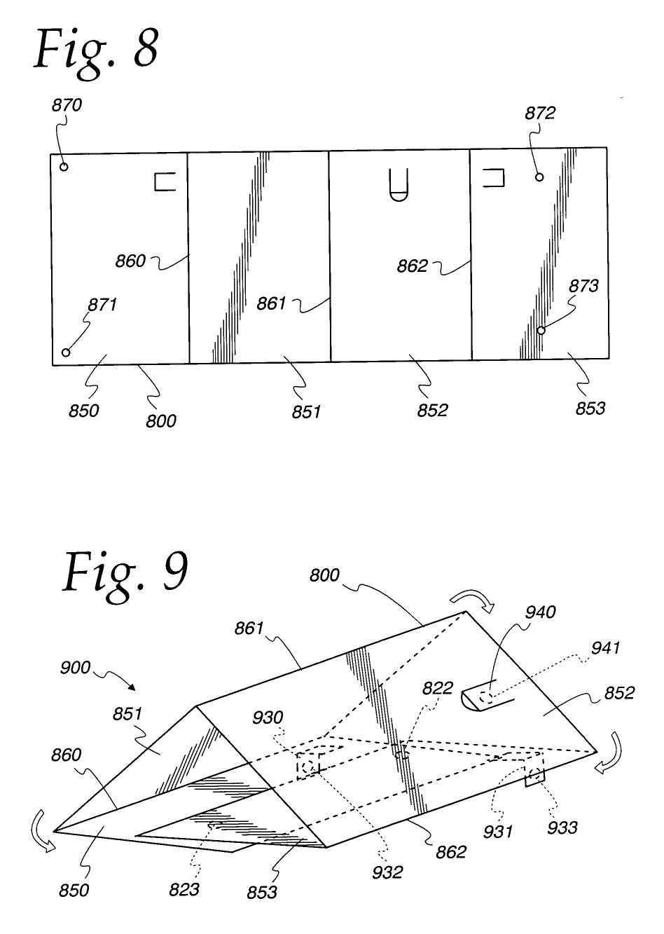

FIG. 8 is a plan view of an example multiple-panel spread story panel 800 configured to form another roof portion of a building-like structure. The example multiple-panel spread story panel 800 is similar to the example multiple-panel spread story panel 600 of FIG. 6. As shown in FIG. 8, the example multiple-panel spread story panel 800 includes four sections or panels 850, 851, 852 and 853 that, when folded along three folding lines 860, 861 and 862, may form another roof portion of a building-like structure. The example multiple-panel spread story panel 800 also includes adhesive placement targets 870, 871, 872 and 873. Additionally, the example multiple-panel spread story panel 800 may form a roof portion using the same or similar method as described in greater detail in connection with FIG. 6. Furthermore, the features associated with the reference numbers 850, 851, 852, 853, 860, 861, 862, 870, 871, 872 and 873 are similar to the respective reference numerals 650, 651, 652, 653, 660, 661, 662, 670, 671, 672 and 673 shown and described in connection with FIG. 6.

FIG. 9 depicts the example multiple-panel spread story panel 800 of FIG. 8 folded to form another example roof portion 900 of a building-like structure. The example roof portion 900 is similar to the example roof portion 700 of FIG. 7. As depicted in FIG. 9, the example roof portion 900 may be formed using the example multiple-panel spread story panel 800 by folding the panels 850, 851, 852 and 853 along the folding lines 860, 861 and 862 and engaging the front side of the panel 850 to the back side of the panel 853 with an adhesive or other fastening material placed on some or all of the adhesive placement target locations 870, 871, 872 and 873. The example roof portion 900 may be affixed or attached to a building-like structure via engagement tabs 930 and 931, which include adhesive target locations 932 and 933 and which include pop-out features similar to the engagement tabs 730 and 731 of FIG. 7. Furthermore, the example roof portion 900 is configured to be attached to a building-like structure and a gable structure (e.g., the example gable structure of FIG. 13) using methods similar to those described in greater detail in connection with FIG. 7. Additionally, the features associated with the reference numbers 930, 931, 932, 933, 940 and 941 are similar to the features associated with the respective reference numbers 730, 731, 732, 733, 740 and 741 of FIG. 7.

FIG. 10 is a plan view of an example multiple-panel spread story panel 1000 configured to form a gable structure. The example multiple-panel spread story panel 1000 includes a first panel or section 1010 and a second panel or section 1011. The second panel or section 1011 includes five sub-sections or segments 1012, 1013, 1014, 1015 and 1016 and six folding lines 1020, 1021, 1022, 1023, 1024 and 1025.

The example multiple-panel spread story panel 1000 may be used to form a gable structure by folding the first panel 1010 and the five segments 1012, 1013, 1014, 1015 and 1016 of the second panel 1011 along the six folding lines 1020, 1021, 1022, 1023, 1024 and 1025. A gable base of a gable structure includes the first panel 1010 and is formed by folding the second panel 1011 along the folding line 1020. An exposed gable face of a gable structure includes the segment 1012 and is formed by folding the second panel 1012 along the folding line 1020 and folding the segments 1013 and 1014 along the folding lines 1021 and 1022, respectively.

A top structural support 1140 (FIG. 11) of a gable structure is provided by the segments 1013, 1014, 1015 and 1016 and is formed by folding the segments 1015 and 1016 along the folding lines 1023 and 1024, respectively, and along the folding line 1025. The segments 1015 and 1016 may be folded along the folding lines 1023, 1024 and 1025 so that the segments 1015 and 1016 collapse toward the base (which is formed by segment 1010) of a gable structure and so that opposing surfaces of the segments 1015 and 1016 lie adjacent to or face each other.

FIG. 11 depicts the example multiple-panel spread story panel 1000 of FIG. 10 folded to form an example gable structure 1100 that is configured to be affixed or attached to a roof portion (e.g., the example roof portion 900 of FIG. 9). The example gable structure 1100 may be configured so that the panel 1010 forms a gable base segment that is attached to the segment 1012 at the folding line 1020. The segment 1012 forms an exposed gable face segment that is attached at the folding lines 1021 and 1022 to the top structural support 1140, which includes the top segment 1014 and an adhesive placement target 1130.

The example gable structure 1100 is configured to be placed within a roof portion such as for example the example roof portion 700 of FIG. 7 and/or the example roof portion 900 of FIG. 9. Furthermore, the example gable structure 1100 may be configured to be adjusted relative to the example roof portion within which it is placed. For example, the example gable structure 1100 may be affixed or attached to the example roof portion 700 using an adhesive or other fastening material. The adhesive or other fastening material may be placed on the adhesive placement target 1130 and may be adhered to an adhesive placement target on the example roof portion 700. The segment 1014 of the example gable structure 1100 may then be affixed or attached to the panel 652 of the example roof portion 700. More specifically, the example gable structure 1100 may be affixed to the example roof portion 700 via the inset tab 740 of the example roof portion 700 by aligning the adhesive placement target 1130 with the adhesive placement target 741 of the inset tab 740. In this manner, the example gable structure 1100 may be attached to the example roof portion 700 so that the surfaces of the panels and segments of the example gable structure 1100 can move relatively freely within the adjoining example roof portion 700.

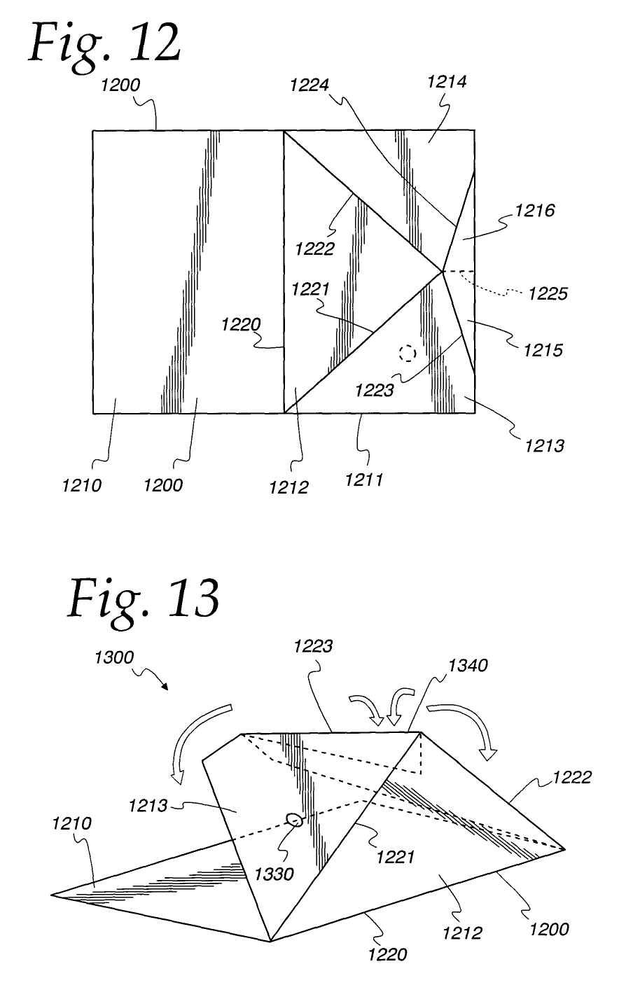

FIG. 12 is a plan view of another example multiple-panel spread story panel 1200 that may be configured to form another gable structure. The example multiple-panel spread story panel 1200 is similar to the example multiple-panel spread story panel 1000 of FIG. 10. The example multiple-panel spread story panel 1200 includes a first panel or section 1210 and a second panel or section 1211. The second panel or section 1211 includes five sub-sections or segments 1212, 1213, 1214, 1215 and 1216 and six folding lines 1220, 1221, 1222, 1223, 1224 and 1225.

The example multiple-panel spread story panel 1200 may be used to form a gable structure by folding the first panel 1210 and the five segments 1212, 1213, 1214, 1215 and 1216 of the second panel 1211 along the six folding lines 1220, 1221, 1222, 1223, 1224 and 1225. A gable base of a gable structure includes the first panel 1210 and is formed by folding the second panel 1011 along the folding line 1020. An exposed gable face of a gable structure includes the segment 1212 and is formed by folding the second panel 1212 along the folding line 1220 and folding the segments 1213 and 1214 along the respective folding lines 1221 and 1222.

FIG. 13 depicts the example multiple-panel spread story panel 1200 of FIG. 12 folded to form another example gable structure 1300 that is configured to be affixed or attached to a roof portion (e.g., the example roof portion 900 of FIG. 9). The example gable structure 1300 is similar to the example gable structure 1100 of FIG. 11. The example gable structure 1300 may be configured so that the panel 1210 forms a gable base that is attached to the segment 1212 at the folding line 1220. The segment 1212 forms an exposed gable face segment that is attached at the folding lines 1221 and 1222 to a top structural support 1340 that includes the segment 1213 and an adhesive placement target 1330.

The example gable structure 1300 is configured to be placed within a roof portion such as, for example, the example roof portion 700 of FIG. 7 and/or the example roof portion 900 of FIG. 9. Furthermore, the example gable structure 1300 may be configured to be adjusted relative to the example roof portion 900. The example gable structure 1300 may be affixed or attached to the example roof portion 900 using an adhesive material. An adhesive or other fastening material may be set on the adhesive placement target 1330 and may be adhered to an adhesive placement target on the example roof portion 900. The top segment 1213 of the example gable structure 1300 may be affixed or attached to the panel 852 of the example roof portion 900. More specifically, the gable structure may be affixed to the example roof portion 900 via the inset tab 940 of the example roof portion 900 by aligning the adhesive placement target 1330 with the adhesive placement target 941 located on the inset tab 940. In this manner, the example gable structure 1300 may be attached to the example roof portion 900 so that the surfaces of the panels and segments of the example gable structure 1300 can move relatively freely within the example roof portion 900.

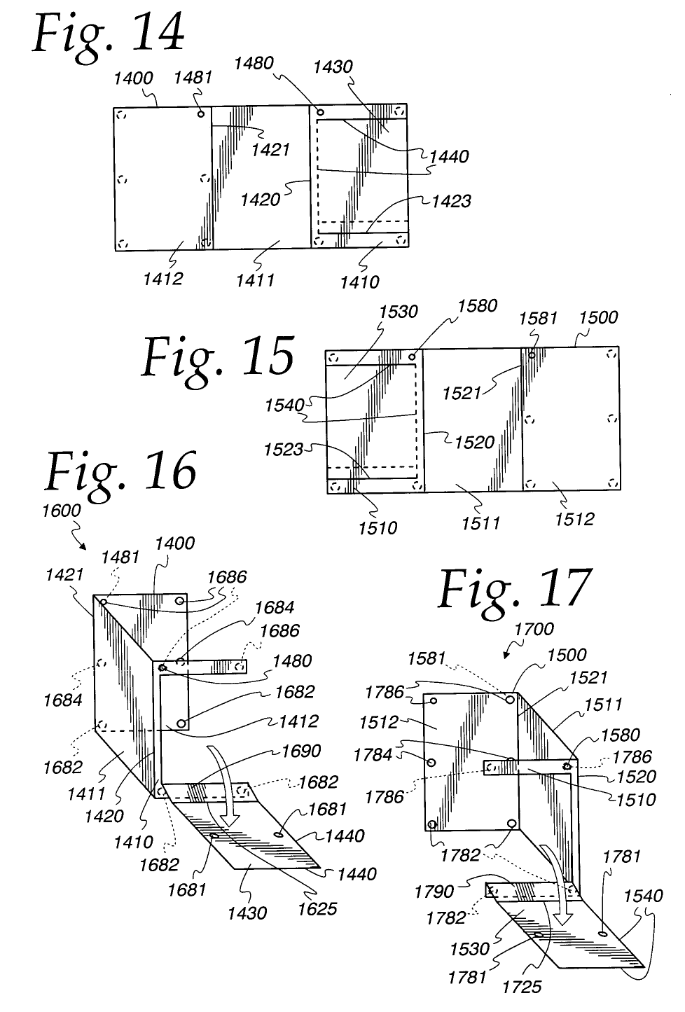

FIGS. 14 and 15 are plan views of example multiple-panel spread story panels 1400 and 1500 that are configured to form two multiple-wall portions of a building-like structure. The example multiple-panel spread story panels 1400 and 1500 may include similar features and may be similarly configured to form the two multiple-wall portions. In particular, the example multiple-panel spread story panel 1400 includes a first panel or section 1410, a second panel or section 1411 and a third panel or section 1412, all of which may be used to form a first multiple-wall portion when folded along folding lines 1420 and 1421. Similarly, the example multiple-panel spread story panel 1500 may form a second multiple-wall portion by folding panels or sections 1510, 1511 and 1512 along folding lines 1520 and 1521. Additionally, the multiple-panel spread story panels 1400 and 1500 each include respective access door portions 1430 and 1530, which are attached to the respective panels 1410 and 1510 via respective semi-perorated features 1440 and 1540.

The access door portion 1430 may be attached to the first panel 1410 by the semi-perforated features 1440 prior to assembling a first multiple-wall portion using the example multiple-panel spread story panel 1400. Additionally, the access door portion 1430 may be configured to be partially separated or popped-out from the first panel 1410 at the semi-perforated features 1440, thereby enabling the access door portion 1430 to be folded along the folding line 1423. Similarly, the panel 1510 of FIG. 15 includes the access door portion 1530, which may be formed via using the perforated features 1540 and the folding line 1523 and a method similar to the method used to form the first access door portion 1430.

When the panels 1410, 1411 and 1412 are folded along the folding lines 1420 and 1421, the example multiple-panel spread story panel 1400 may form a first multiple-wall portion and may be configured to engage with a roof portion (e.g., the example roof portion 700 of FIG. 7). In particular, an adhesive or other fastening material may be applied to one or both of the adhesive placement targets 1480 and 1481 printed on the first panel 1410 and the third panel 1412, respectively, thereby enabling the example multiple-panel spread story panel 1400 to be attached to the example roof portion 700. More specifically, the example multiple-panel spread story panel 1400 may be folded so that the adhesive placement targets 1480 and 1481 align with the respective adhesive placement targets 732 and 733 shown in FIG. 7.

Similarly, the example multiple-panel spread story panel 1500 may form a second multiple-wall portion by folding the panels 1510, 1511 and 1512 along the folding lines 1520 and 1521. The example multiple-panel spread story panel 1500 may also be configured to engage with a roof portion (e.g., the example roof portion 900 of FIG. 9) using the adhesive placement targets 1580 and 1581 that are located on the panels 1510 and 1511 as shown in FIG. 15. More specifically, a multiple-wall portion formed by the example multiple-panel spread story panel 1500 may be configured so that the adhesive placement targets 1580 and 1581 align with the respective adhesive placement targets 932 and 933 of the example roof portion 900.

FIGS. 16 and 17 depict the example multiple-panel spread story panels 1400 and 1500 of FIGS. 14 and 15 folded to form example multiple-wall portions 1600 and 1700. The panels 1410, 1411 and 1412, when folded along the folding lines 1420 and 1421, form part of a rear wall, part of a side wall and part of a front wall, respectively. Similarly, the panels 1510, 1511 and 1512, when folded along the folding lines 1520 and 1521, form part of a rear wall, part of a side wall and part of a front wall, respectively.

The panel 1410, which forms a part of a rear wall, includes the access door portion 1430, which is shown in an open configuration in FIG. 16. Additionally, the semi-perforated features 1440 enable the access door portion 1430 to be partially separated or detached from the panel 1410, which forms a part of a front wall. Further, separating the access door portion 1430 from the panel 1410 at the semi-perforated features 1440 enables the access door portion 1430 to be hinged or partially attached to the panel 1410 at the folding line 1423. The access door portion 1430 may be opened away from the example multiple-wall portion 1600 by folding the access door portion 1430 along the folding line 1423. When the access door portion 1430 is opened, a double hinge 1690 may be formed by folding the access door portion 1430 along a folding line 1625. In this manner, the access door portion 1430 can be made to lie flat against a supporting surface such as, for example, a table top surface or a floor surface where a building-like structure may be placed. In addition, the double hinge 1690 may also prevent unpredictable and/or unwanted damage to the access door portion 1430 in the open position during normal use.

Similarly, the panel 1510 includes the access door portion 1530, which is shown in an open configuration in FIG. 17. The method used for forming the access door portion 1530 may be the same as or similar to the above-described method used for forming the access door portion 1430. Thus, the features associated with reference numbers 1500, 1512, 1523, 1530, 1540, 1725 and 1790 are similar to the features associated with the respective reference numbers 1400, 1412, 1423, 1430, 1440, 1625 and 1690.

The example multiple-wall portions 1600 and 1700 may be configured to be attached to roof portions (e.g., the example roof portion 900 of FIG. 9 and the example roof portion 700 of FIG. 7), multiple floor structures and a ceiling structure. In particular, the example roof portions 700 and 900, the multiple floor structures and the ceiling structure may be attached to the example multiple-wall portions 1600 and 1700 via an adhesive or other fastening material placed on one or more of the adhesive placement targets 1480, 1481, 1580, 1581, 1682, 1684, 1686, 1782, 1784, 1786, 1681 and 1781. The adhesive placement targets 1480 and 1481 are located on the example multiple-wall portion 1600 to align with the adhesive placement targets 732 and 733 located on the example roof portion 700 (FIG. 7), the multiple floor structures and the ceiling structure. Similarly, the adhesive placement targets 1580 and 1581 may be located on the example multiple-wall portion 1700 to align with the adhesive placement targets 933 and 932 on the example roof portion 900, multiple floor structures and a ceiling structure.

The example roof portion 700 (FIG. 7) may be adhered or attached to the top of the example multiple-wall portion 1600 by placing the base of the example roof portion 700, formed by the panels 650 and 653, on top of the example multiple-wall portion 1600 and aligning the adhesive placement target 1480 with the adhesive placement target 732 of the example roof portion 700 shown in FIG. 7. In particular, the adhesive placement target 1480 may be attached or adhered to the adhesive placement target 732 via an adhesive or other fastening material (e.g., glue, Velcro, etc.) placed on one or both of the adhesive placement targets 1480 and 732. In the same manner, the example roof portion 900 may be affixed or attached to the top of the example multiple-wall portion 1700 using an adhesive or other fastening material placed on one or both of the adhesive placement targets 1580 and 933.

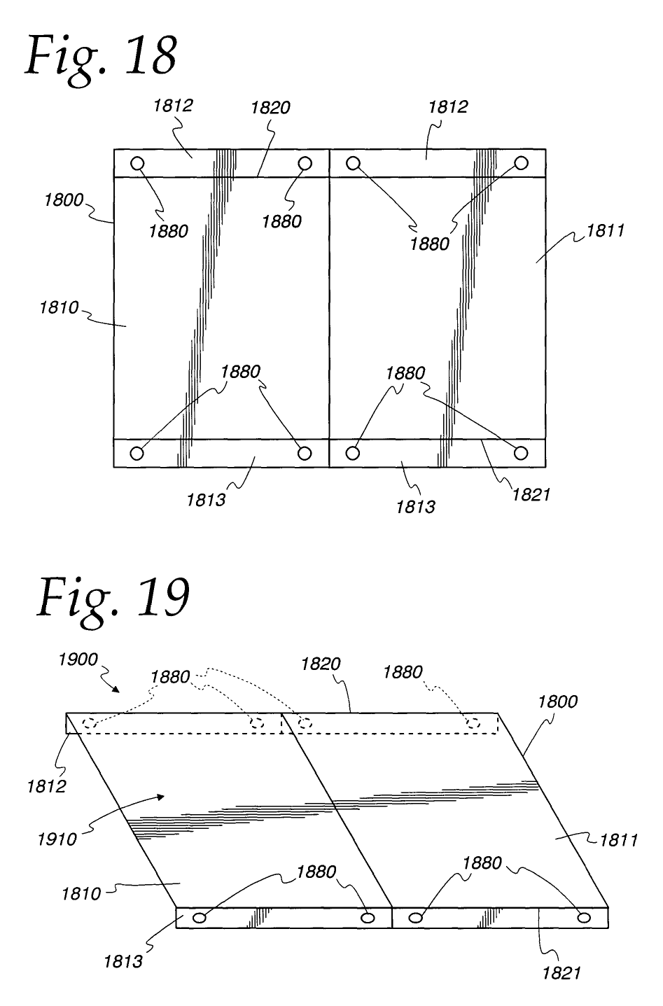

FIG. 18 is a plan view of an example multiple-panel spread story panel 1800 that is configured to form a ceiling structure or a floor structure of a building-like structure. The example multiple-panel spread story panel 1800 includes two panels 1810 and 1811 and bracing strips 1812 and 1813, which are attached to the panels 1810 and 1811 so that when folded along folding lines 1820 and 1821 the panels 1810 and 1811 may form a ceiling structure or a floor structure of a building-like structure. The, a ceiling structure or floor structure formed using the multiple panel spread story panel 1800 may be affixed or attached to a building-like structure by using an adhesive or other fastening material at one or more adhesive placement targets 1880 located on the bracing strips 1812 and 1813.

FIG. 19 is the example multiple-panel spread story panel 1800 of FIG. 18 folded to form a ceiling structure or floor structure 1900 of a building-like structure. The ceiling structure or floor structure 1900 includes a horizontal surface 1910 that includes the panels 1810 and 1811, which are attached to the bracing strips 1812 and 1813 at the folding lines 1820 and 1821, respectively. The ceiling structure or floor structure 1900 may be attached to the example multiple-wall portions 1600 and 1700 shown in FIGS. 16 and 17 via an adhesive material placed on one or more of the adhesive placement targets 1880 and/or the adhesive placement targets 1680, 1780, 1681, 1781, 1682 and 1782 of FIGS. 16 and 17.

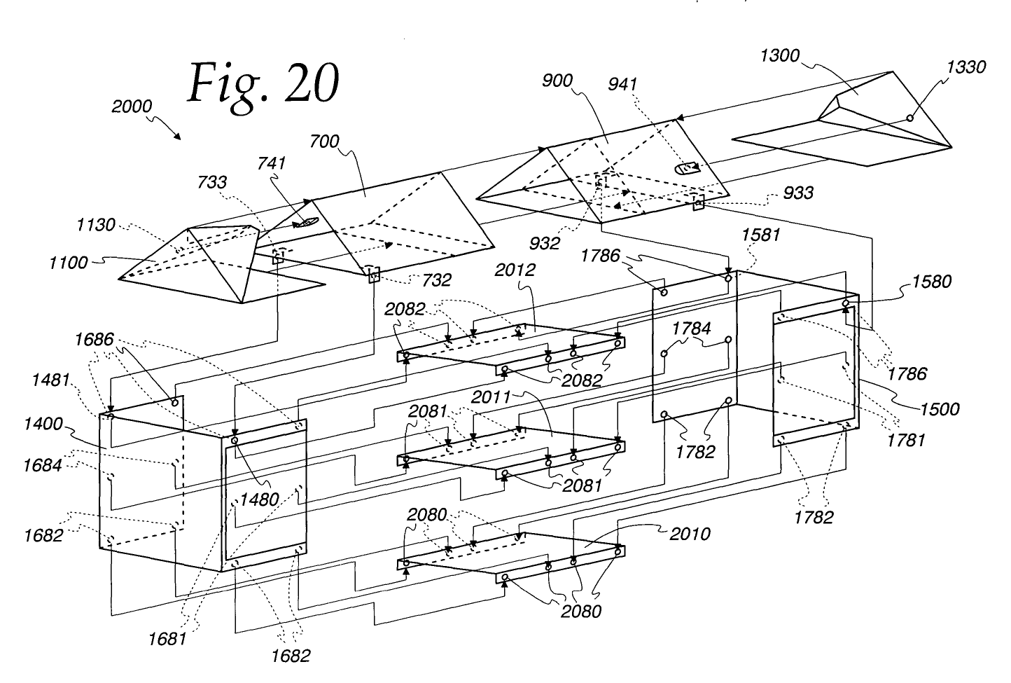

FIG. 20 is an exploded isometric view of a building-like structure 2000 that may be formed using the removably attached story panels described herein. As depicted in FIG. 20, the building-like structure 2000 includes the example roof portions 700 and 900, the example gable structures 1100 and 1300 and the example multiple-wall portions 1600 and 1700. In addition, the building-like structure 2000 includes a first-floor structure 2010, a second-floor structure 2011 and a ceiling structure 2012, all of which may be formed using the example structure 1900 shown in FIG. 19. The example gable structures 1100 and 1300 engage with the respective example roof portions 700 and 900. The example roof portions 700 and 900 engage with the respective example multiple-wall portions 1600 and 1700. The example multiple-wall portions 1600 and 1700 engage with the first-floor structure 2010, the second-floor structure 2011 and the ceiling structure 2012.

The example gable structures 1100 and 1300 may engage with the respective example roof portions 700 and 900 via an adhesive or other fastening material placed on some or all of the adhesive placement targets 741, 941, 1130 and 1330. In particular, the example gable structures 1100 and 1300 may be placed within the respective example roof portions 700 and 900 so that the adhesive placement targets 1130 and 1230 of the example gable structures 1100 and 1300 align with the respective adhesive placement targets 741 and 941 of the example roof portions 700 and 900 (FIGS. 7 and 9).

The example roof portions 700 and 900 may be joined to form a roof by sliding at least a portion of the example roof portion 900 into at least a portion of the example roof portion 700. Furthermore, the example roof portions 700 and 900 may be affixed or attached to the respective example multiple-wall portions 1600 and 1700 via an adhesive or other fastening material placed on some or all of the adhesive placement targets 732, 733, 932, 933, 1480, 1481, 1580 and 1581. In particular, the example roof portions 700 and 900 may be placed on top of the respective example multiple-wall portions 1600 and 1700 so that the adhesive placement targets 732, 733, 932 and 933 align with the respective adhesive placement targets 1480, 1481, 1580 and 1581.

The ceiling structure 2012 may be similar to the example structure 1900 of FIG. 19. Furthermore, the ceiling structure 2012 may be affixed or attached to the example multiple-wall portions 1600 and 1700 via an adhesive or other fastening material placed on some or all of the adhesive placement targets 1682, 1782 and 2082. In particular, the ceiling structure 2012 may be attached to the example multiple-wall portions 1600 and 1700 by aligning the adhesive placement targets 2082 with the adhesive placement targets 1686 and 1786.

The second-floor structure 2011 may be similar to the example structure 1900 of FIG. 19. Furthermore, the second-floor structure 2011 may be affixed or attached to the example multiple-wall portions 1600 and 1700 via an adhesive or other fastening material placed on some or all of the adhesive placement targets 1681, 1781 and 2081. In particular, the second-floor structure 2011 may be attached to the example multiple-wall portions 1600 and 1700 by aligning the adhesive placement targets 2081 with the adhesive placement targets 1681 and 1781.

The first-floor structure 2010 may be similar to the example structure 1900 of FIG. 19. Furthermore, the first-floor structure 2010 may be affixed or attached to the example multiple-wall portions 1600 and 1700 via an adhesive or other fastening material placed on some or all of the adhesive placement targets 1680, 1780 and 2080. In particular, the first-floor structure 2010 may be attached to the example multiple-wall portions 1600 and 1700 by aligning the adhesive placement targets 2080 with the adhesive placement targets 1680 and 1780.

FIG. 21 is a detailed exterior view of an example building-like structure 2100 that may be formed using the removably attached story panels described herein. The methods and panels described herein may be used to form the example building-like structure 2100, which may be associated with a house or other building-like structures such as, for example, a barn, a school house, a factory building, etc. The example building-like structure 2100 may be formed using multiple story panels similar or identical to the story panels 110 and 410 of FIGS. 1-4. In an open-panel configuration, the story panels may form multiple-panel spread story panels similar or identical to the multiple-panel spread story panels 500, 600, 800, 1000, 1200, 1400, 1500 and 1800 of FIGS. 5-19.

The example building-like structure 2100 includes a gable face 2112 that may be formed by the example gable structures 1100 and 1300 of FIGS. 11 and 13. A roof 2152 of the example building-like structure 2100 may be formed using the example roof portions 700 and 900 of FIGS. 7 and 9. A front wall 2110 and a side wall 2111 of the example building-like structure 2100 may be formed using the example multiple-panel spread story panels 1400 and 1500 of FIGS. 14-17. Additionally, the front wall 2110 includes an access door 2140 that is similar or identical to the access door portions 1430 and 1530 of FIGS. 14-17. The example building-like structure 2100 also includes window-like features 2190 and door-like features 2192 that may be configured to pop-out via semi-perforated features and that are similar or identical to the pop-out features 540 of FIG. 5.

The graphical information on the visible surfaces of the example building-like structure 2100 may include windows, doors, roof shingles, exterior siding, etc. More generally, any building-like structure formed using similar methods and panels described herein may include graphical information that is related to the characteristics of the building-like structure on visible surfaces. For example, a barn structure may include red-colored exterior walls and graphical information that is associated with farm animals, hay and/or farm equipment. Furthermore, the graphical information and the pop-out features 2190 and 2192 on the example building-like structure 2100 are similar to the normally hidden graphical information 530 and the pop-out features 540 of FIG. 5. Therefore, the graphical information and pop-out features 2190 and 2192 may be hidden when the panels that include the graphical information and the pop-out features 2190 and 2192 are in the closed panel configuration, as described by way of example above in greater detail in connection with FIG. 5. Additionally, non-visible surfaces of panels that are configured to form the building-like structure 2100 may include textual and graphical information that are similar or identical to the normally visible printed information 520 of the closed-panel configuration as described in greater detail in connection with FIG. 5.

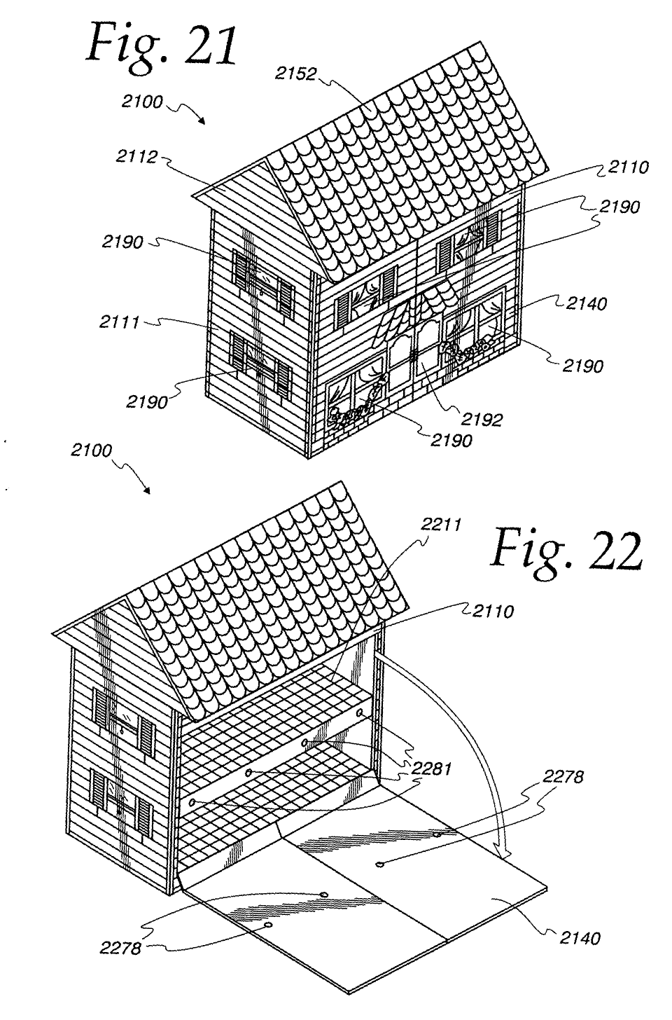

FIG. 22 illustrates the access door 2140 of the example building-like structure 2100 of FIG. 21 in an open-door configuration. The access door 2140 may be similar or identical to the access door portions 1430 and 1530 of FIGS. 14-17. As shown in FIG. 22, the access door 2140 may be made to form an open-door configuration by folding or opening the access door 2140 in a perpendicular direction to the front wall 2110. On the other hand, as shown in FIG. 21, the access door 2140 may be made to form a closed-door configuration by moving the access door 2140 to an upright position, thereby creating a flush surface with the front wall 2110. Additionally, the access door 2140 may be adhered or attached to a second-floor structure 2211 via an adhesive or other fastening material that is placed on the adhesive placement targets 2281 and/or the adhesive placement targets 2278. Furthermore, in the upright position, the access door 2140 may be fixed in a closed-door configuration by aligning the adhesive placement targets 2281 with the adhesive placement targets 2278.

Although the removably attached story panels 410 of FIG. 4 may be configured to form a building-like structure such as, for example, the building-like structure 2100 of FIGS. 21 and 22, the removably attached story panels 410 are not limited to forming a building-like structure. In particular, at least one of the removably attached story panels 410 may be configured to form a game or portion of a game as described in greater detail in connection with FIGS. 23 and 24. Furthermore, a book-like article (e.g., the book-like article 100 of FIGS. 1-4) may include at least some of the removably attached story panels 410 that may be configured to form a building-like structure and at least one of the removably attached story panels 410 that may be configured to form a game or portion of a game.

FIG. 23 illustrates an example multiple-panel spread story panel 2310 configured to form a game. The example multiple-panel spread story panel 2310 as depicted in FIG. 23 is shown in an open-panel configuration. In the open-panel configuration, normally hidden surfaces 2320 and 2324 that include normally hidden graphical information 2330 are exposed on the example multiple-panel spread story panel 2310. The normally hidden surfaces 2320 and 2324 may be folded along folding line 2326 to form a closed-panel configuration so that the normally hidden surface 2320 faces the normally hidden surface 2324, thereby hiding the graphical information 2330. In addition, when in a closed-panel configuration, the example multiple-panel spread story panel 2310 may be configured to expose a normally visible surface (e.g., similar to the normally visible surface 510 of FIG. 5) that includes normally visible graphical information (e.g., similar to the normally visible graphical information 240 of FIG. 2) and normally visible textual information (e.g., similar to the normally visible textual information 230 of FIG. 2).

In an open-panel configuration, the example multiple-panel spread story panel 2310 may form a game or portion of a game (e.g., a chess board, a checkers board, a role-playing board, etc.). Graphical information such as, for example, the graphical information 2330 and/or game-related textual information (not shown) may be hidden when the example multiple-panel spread story panel 2310 is in a closed-panel configuration. The example multiple-panel spread story panel 2310 may be associated with game components 2350 or game pieces (e.g., checkers pieces, game cards, player identifiers, etc.) that may be related to a game.

FIG. 24 is an example game components panel 2410. The example game components panel 2410 may include game components 2450 (e.g., the game components 2350 of FIG. 23) that may be removably attached to the example game components panel 2410 via semi-perforated features. The example game components panel 2410 may be configured to form a multiple-panel spread story panel such as, for example, the multiple-panel spread story panel 2310 of FIG. 23 and may be removably attached to a book-like article such as, for example, the book-like article 100 of FIG. 1. Alternatively, the example game components panel 2410 may be included in a book-like article in a loose fashion (e.g., a panel insert) during a post-binding process so that the example game components panel 2410 can be easily removed from the book-like article without having to remove one or more of the removably attached story panels such as, for example, the removably attached story panels 410 of FIG. 4.

The game components 2450 may be associated with a game, such as, for example, the game that may be formed by the example multiple-panel spread story panel of FIG. 23. Additionally or alternatively, the game components 2450 may be associated with a building-like structure such as, for example, the building-like structure 2100 of FIGS. 21 and 23. Furthermore, the game components 2450 may form a game that is independent of a building-like structure and the game that may be formed by the example multiple-panel spread story panel 2310.

Although certain methods and apparatus have been described herein, the scope of coverage of this patent is not limited thereto. To the contrary, this patent covers all embodiments fairly falling within the scope of the appended claims either literally or under the doctrine of equivalents.

1. A book comprising:
a plurality of story panels, wherein each of the plurality of story panels is attached to at least another one of the plurality of story panels and at least one of the plurality of story panels includes textual information on a first surface and graphical information on a second surface, and wherein at least some of the plurality of story panels are removably attached to the book and configurable to be assembled to form a structure associated with the textual information and so that the graphical information is exposed to a viewer and is aesthetically complementary to the structure and the textual information.

2. A book as defined in claim 1, wherein the first surface is viewable and the second surface is not viewable when the at least one of the plurality of story panels is attached to the book.

3. A book as defined in claim 1, wherein the at least one of the plurality of story panels is configurable to form a multiple-panel spread story panel.

4. A book as defined in claim 3, wherein the multiple-panel spread story panel includes at least three panels.

5. A book as defined in claim 3, wherein the multiple-panel spread story panel is of a unitary construction.

6. A book as defined in claim 1, wherein the at least one of the plurality of story panels has a third surface facing the second surface.

7. A book as defined in claim 1, wherein the structure is a building-like structure.

8. A book as defined in claim 7, wherein the building-like structure comprises the characteristics of a house.

9. A book as defined in claim 1, wherein the textual information is associated with at least one of assembly instructions, a children's story, and a game.

10. A book as defined in claim 1, wherein the graphical information includes characteristic detail associated with the structure.

11. A book as defined in claim 1, wherein at least two of the plurality of story panels are attached to each other.

12. A book as defined in claim 11, wherein the at least two of the plurality of story panels are attached to each other via a fugitive adhesive.

13. A book as defined in claim 12, wherein the fugitive adhesive is a hot-melt adhesive.

14. A book as defined in claim 11, wherein the at least two of the plurality of story panels are configurable to be removed from each other with expected structural results.

15. A book as defined in claim 11, wherein the at least two of the plurality of story panels are configured to be removed from each other via at least one semi-perforated feature.

16. A book as defined in claim 1, wherein at least one of the plurality of story panels is configurable to form at least a portion of a board game.

17. A book as defined in claim 16, wherein the at least one of the plurality of story panels includes at least one visible surface and at least one hidden surface.

18. A book as defined in claim 17, wherein the at least one visible surface includes textual information associated with at least one of assembly instructions and a story, and wherein the at least one hidden surface includes graphical information associated with at least one of the structure and a game.

19. A book as defined in claim 1, wherein the textual information and the graphical information are associated with printed information.

20. A book-like article comprising:
a plurality of story panels; and
a plurality of surfaces associated with the story panels, including at least one visible surface including textual information and at least one hidden surface including graphical information, wherein at least some of the plurality of surfaces are configurable to be assembled to form a structure associated with the textual information and so that the graphical information is exposed.

21. A book-like article as defined in claim 20, wherein the at least some of the plurality of surfaces are configured to be adhered to each other.

22. A book-like article as defined in claim 21, wherein the at least some of the plurality of surfaces are configured to be attached to each other via a fugitive adhesive.

23. A book-like article as defined in claim 20, wherein the at least some of the surfaces are associated with multiple-panel spread story panels.

24. A book-like article as defined in claim 23, wherein at least one of the multiple-panel spread story panels includes three panels.

25. A book-like article as defined in claim 20, wherein at least one of the plurality of story panels includes two opposing visible surfaces and two hidden surfaces that face each other.

26. A book-like article as defined in claim 20, wherein at least one surface of each of the plurality of story panels is joined to a surface associated with another one of the plurality of story panels.

27. A book-like article as defined in claim 26, wherein the at least one surface of each of the plurality of story panels is attached to the surface associated with another one of the plurality of story panels.

28. A book-like article as defined in claim 26, wherein the at least one surface of each of the plurality of story panels and the surface associated with another one of the plurality of story panels are attached via at least one fastener.

29. A book-like article as defined in claim 20, wherein the plurality of story panels are removably attached to each other.

30. A book-like article as defined in claim 20, wherein the plurality of story panels are configured to be removed with expected structural results.

31. A book-like article as defined in claim 30, wherein the plurality of story panels are configured to be removed via at least one semi-perforated feature.

32. A book-like article as defined in claim 20, wherein the structure is a building-like structure.

33. A book-like article as defined in claim 20, wherein the at least some of the plurality of surfaces are joined via at least one fastener.

34. A book-like article as defined in claim 33, wherein the at least some of the plurality of surfaces include predetermined areas for the at least one fastener.

35. An article having a building-like appearance comprising:
a plurality of story panels, wherein at least some of the plurality of story panels have at least one visible surface and one hidden surface, and wherein at least one surface of each of the plurality of story panels is joined to a surface of an adjacent story panel.

36. An article as defined in claim 35, wherein at least one of the plurality of story panels includes an inset tab configurable to facilitate its alignment.

37. An article as defined in claim 36, wherein the inset tab is configurable to be accessed on the at least one visible surface.

38. An article as defined in claim 35, wherein at least some of the surfaces are adhered to each other via a fastener.

39. An article as defined in claim 35, wherein at least some of the surfaces include semi-perforated features associated with the structure, including at least one of a window, door, and a pop-up feature.

40. An article as defined in claim 35, wherein each of the plurality of story panels is formed using a contiguous piece of material.

41. An article as defined in claim 35, wherein at least one of the plurality of story panels is rigid.

42. An article comprising:
a plurality of story panels; and
a plurality of surfaces associated with at least some of the plurality of story panels, including at least one visible surface and at least one hidden surface, wherein the at least one visible surface includes textual information, and wherein the at least one hidden surface includes graphical information.

43. An article as defined in claim 42, wherein at least one of the story panels is configurable to form a portion of a game.

44. An article as defined in claim 42, wherein the textual information includes at least one of assembly instructions and a story, and wherein the graphical information is associated with at least one of the story and a game.

45. An article as defined in claim 42, wherein the at least some of the plurality of story panels are removably attached to each other.

46. An article as defined in claim 42, wherein at least one of the plurality of story panels is configurable to form a game component panel.

47. An article as defined in claim 46, wherein the game component panel is configurable to provide components associated with a game.

48. An article as defined in claim 47, wherein the components associated with the game are attached to the game component panel via semi-perforated features.

49. A book-like article comprising:
a plurality of removable panels, wherein at least two of the plurality of removable panels are multiple panel spreads, each of which is removably attached to a common binding edge of the book-like article and each of which includes a plurality of surfaces having at least a first surface and an opposing second surface facing the first surface so that the first and second surfaces may be viewed simultaneously, wherein each of the first and second surfaces includes at least one of textual information and graphical information that is associated with the other surface, and wherein the at least two of the plurality of story panels are configurable to form a structure independent of the book-like article to expose at least some of the plurality of surfaces.

50. A book-like article as defined in claim 49, wherein the at least two of the plurality of removable panels are removably attached to the common binding edge of the book-like article via a fugitive adhesive.

51. A book-like article as defined in claim 50, wherein the fugitive adhesive is a hot melt adhesive.

52. A book-like article as defined in claim 49, wherein the plurality of surfaces includes at least one hidden surface and at least one visible surface when the at least two of the plurality of removable panels is removably attached to the common binding edge of the book-like article.

53. A book-like article as defined in claim 49, wherein the at least one of textual information and graphical information is associated with at least one of instructional information, a story, and a game.
